(19) United States
(12) Patent Application Publication
(10) Pub. No.: US 2025/0306620 A1
(43) Pub. Date: Oct. 2, 2025

(54) VOLTAGE REGULATOR AND SEMICONDUCTOR DEVICE

(71) Applicant: ABLIC Inc., Nagano (JP)

(72) Inventors: Kohei MIZUTA, Nagano (JP); Yasuhiko OGURA, Nagano (JP); Noriyuki HARADA, Nagano (JP)

(73) Assignee: ABLIC Inc., Nagano (JP)

(21) Appl. No.: 19/023,403

(22) Filed: Jan. 16, 2025

(30) Foreign Application Priority Data
Mar. 28, 2024 (JP) 2024-052909
Sep. 30, 2024 (JP) 2024-170767

(51) Int. Cl. G05F 1/575; G05F 1/59

(52) U.S. Cl. CPC G05F 1/575; G05F 1/59

(57) ABSTRACT

A voltage regulator includes: a first transistor provided between an input terminal to which an input voltage is applied and an output terminal from which an output voltage is outputted; a differential amplifier circuit connected to provide negative feedback between a predetermined reference voltage and a voltage based on the output voltage outputted from the output terminal; and an inverting amplifier connected to an output terminal of the differential amplifier circuit, a gate terminal of the first transistor, and the input terminal. The inverting amplifier includes: a second transistor including a gate terminal connected to the output terminal of the differential amplifier circuit, and a source terminal which is grounded; and a current adjustment circuit capable of flowing current from the input terminal to the second transistor even with a gate voltage of the first transistor being in the vicinity of a threshold voltage.

### CROSS-REFERENCE TO RELATED APPLICATION

This application claims the priority benefit of Japan application serial no. 2024-052909, filed on Mar. 28, 2024 and Japan application serial no. 2024-170767, filed on Sep. 30, 2024. The entirety of the above-mentioned patent applications is hereby incorporated by reference herein and made a part of this specification.

### BACKGROUND

### Technical Field

The present invention relates to a voltage regulator and a semiconductor device.

### Related Art

Conventionally, voltage regulators capable of outputting a constant voltage lower than an input voltage have been widely used as integrated circuits (ICs) for power supply of electronic devices. Such voltage regulators include a phase compensation function capable of suppressing oscillation. For example, the conventional art discloses a voltage regulator with a phase compensation function.

Herein, there is a problem that phase compensation becomes difficult in the case where a capacitance value of an output capacitor is reduced. To solve this problem, the art described above further includes a P-channel type metal-oxide-semiconductor field-effect transistor (MOSFET) in parallel with the output transistor. The P-channel type MOSFET is required to be large to an extent capable of actively utilizing the parasitic capacitance of the transistor. Specifically, referring to FIG. 8 to FIG. 10, the problem associated with the conventional art will be described.

FIG. 8 is a circuit diagram illustrating a voltage regulator according to the conventional art. First, referring to this figure, a circuit configuration of a voltage regulator 90 according to the conventional art will be described. The voltage regulator 90 includes an output transistor 91, a P-channel type transistor 92, an N-channel type transistor 93, a differential amplifier circuit 94, a resistor 95, a resistor 96, a capacitor 97, an output capacitor 98, and an output resistor 99.

In the voltage regulator 90 according to the conventional art, it is common that the output transistor 91 and the P-channel type transistor 92 with a mirror structure are configured as elements including the same structure as each other. In other words, in the conventional art, it is common that the output transistor 91 and the P-channel type transistor 92 have the same threshold voltage as each other (threshold voltage Vth₉₁=threshold voltage Vth₉₂).

FIG. 9 is a graph illustrating changes in a gain and a phase upon varying a frequency in a voltage regulator according to the conventional art. The presented example illustrates changes in the gain and the phase upon varying the frequency in the case where the capacitance value of the output capacitor 98 in FIG. 8 is sufficient. (A) of FIG. 9 illustrates a relationship between the frequency [Hz] and the gain [dB], and (B) of FIG. 9 illustrates a relationship between the frequency [Hz] and the phase [°].

A frequency F_{P1} of a first pole is a frequency of the first pole generated by the output capacitor 98. A frequency F_{P2} of a second pole is a frequency of the second pole generated by the parasitic capacitance formed between the source terminal and the gate terminal of the output transistor 91. As illustrated in the figure, the frequency F_{P1} of the first pole and the frequency F_{P2} of the second pole are sufficiently separated, and a zero-crossing frequency F_{ZC} at which the gain becomes 0 [dB] is located between the frequency F_{P1} of the first pole and the frequency F_{P2} of the second pole. Referring to (B) of FIG. 9, the phase at the zero-crossing frequency F_{ZC} is about 90[°], which is sufficiently greater than 0. Thus, in the case where the capacitance value of the output capacitor is sufficient, phase compensation is possible.

FIG. 10 is a graph illustrating changes in the gain and the phase upon varying the frequency in the case where the capacitance value of the output capacitor of the voltage regulator according to the conventional art is small. The presented example illustrates changes in the gain and the phase upon varying the frequency in the case where the capacitance value of the output capacitor 98 in FIG. 8 is small. (A) of FIG. 10 illustrates a relationship between the frequency [Hz] and the gain [dB], and (B) of FIG. 10 illustrates a relationship between the frequency [Hz] and the phase [°].

In the case where the capacitance value of the output capacitor is small, the frequency F_{P1} of the first pole shifts to the high-frequency side and approaches the frequency F_{P2} of the second pole generated at the gate terminal of the output transistor 91. The zero-crossing frequency F_{ZC} in the case where the capacitance value of the output capacitor is small shifts to the high-frequency side, and the phase at the zero-crossing frequency F_{ZC} is about 0[°]. Thus, it is learned that, in the case where such a circuit configuration is adopted, phase compensation becomes difficult in the case where the capacitance value of the output capacitor is small.

In a circuit such as the one described in the conventional art, phase compensation is made possible by shifting the frequency F_{P2} of the second pole generated at the gate terminal of the output transistor to the low-frequency side, using the resistor and the parasitic capacitance of a second output transistor connected in parallel with the output transistor. However, it is expected that the area of the second output transistor having a parasitic capacitance necessary for phase compensation is large, and the overall area of the voltage regulator 90 becomes large.

### SUMMARY

A voltage regulator according to an aspect of the present invention includes a first transistor, a differential amplifier circuit, and an inverting amplifier. The first transistor is provided between an input terminal to which an input voltage is applied and an output terminal from which an output voltage is outputted. The differential amplifier circuit is connected to provide negative feedback between a predetermined reference voltage and a voltage based on the output voltage outputted from the output terminal. The inverting amplifier is connected to an output terminal of the differential amplifier circuit, a gate terminal of the first transistor, and the input terminal. The inverting amplifier includes a second transistor and a current adjustment circuit. The second transistor includes a gate terminal connected to the output terminal of the differential amplifier circuit, and a source terminal which is grounded. The current adjustment circuit is capable of flowing current from the input terminal to the second transistor even with a gate voltage of the first transistor being in the vicinity of a threshold voltage.

According to embodiments of the present invention, it is possible to provide a voltage regulator and a semiconductor device capable of performing phase compensation without significantly increasing the circuit area even in the case of increasing the capacitance value of the output capacitor.

### BRIEF DESCRIPTION OF THE DRAWINGS

FIG. 1 is a circuit diagram illustrating a voltage regulator according to a first embodiment.

FIG. 2 is a graph illustrating changes in a gain and a phase upon varying a frequency in the case where a capacitance value of an output capacitor is small in the voltage regulator according to the first embodiment.

FIG. 3 is a circuit diagram illustrating a voltage regulator according to a second embodiment.

FIG. 4 is a circuit diagram illustrating a voltage regulator according to a third embodiment.

FIG. 5 is a circuit diagram illustrating a voltage regulator according to a fourth embodiment.

FIG. 6 is a circuit diagram illustrating a voltage regulator according to a fifth embodiment.

FIG. 7 is a circuit diagram illustrating a voltage regulator according to a sixth embodiment.

FIG. 8 is a circuit diagram illustrating a voltage regulator according to a conventional art.

FIG. 9 is a graph illustrating changes in a gain and a phase upon varying a frequency in the voltage regulator according to the conventional art.

FIG. 10 is a graph illustrating changes in the gain and the phase upon varying the frequency in the case where a capacitance value of an output capacitor is small in the voltage regulator according to the conventional art.

### DESCRIPTION OF THE EMBODIMENTS

Embodiments of the present invention provide a voltage regulator and a semiconductor device capable of performing phase compensation without significantly increasing a circuit area even in the case of reducing a capacitance value of an output capacitor.

### Embodiments

Hereinafter, a voltage regulator according to an aspect of the present invention will be described in detail based on exemplary embodiments with reference to the accompanying drawings.

### First Embodiment

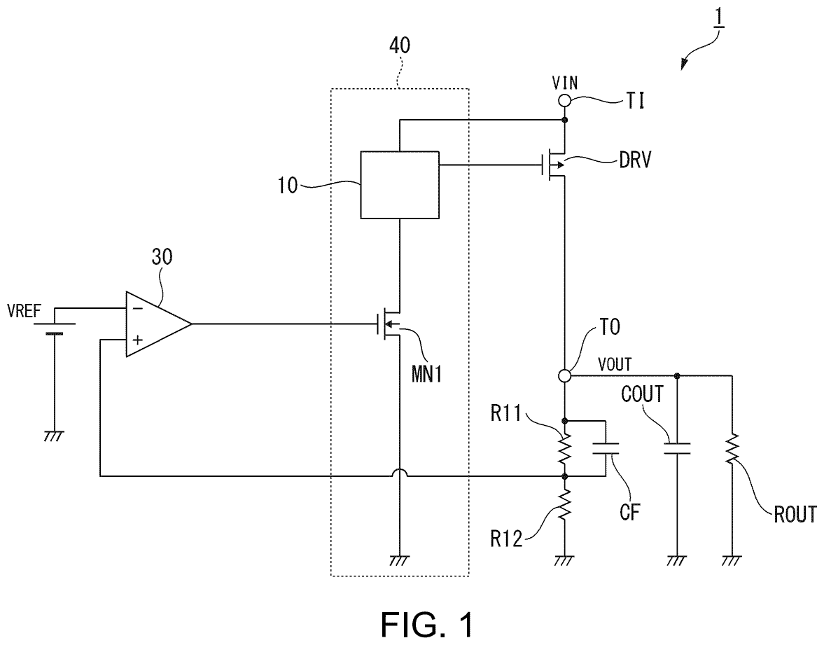

FIG. 1 is a circuit diagram illustrating a voltage regulator according to a first First, a circuit configuration of a voltage regulator 1 will be described with embodiment. reference to this figure. The voltage regulator 1 includes an output transistor DRV, a differential amplifier circuit 30, an inverting amplifier 40, a resistor R11, a resistor R12, a capacitor CF, an output capacitor COUT, and an output resistor ROUT. Not all of these elements included in the voltage regulator 1 need to be provided within one IC, and some elements (e.g., the output capacitor COUT and the output resistor ROUT serving as loads, the resistor R11 and the resistor R12 serving as voltage dividing resistors, the capacitor CF, etc.) may also be present outside the IC.

The output transistor DRV is provided between an input terminal TI to which an input voltage VIN is applied, and an output terminal TO from which an output voltage VOUT is outputted. The source terminal of the output transistor DRV is connected to the input terminal TI. In addition, the drain terminal of the output transistor DRV is connected to the output terminal TO. In addition, the gate terminal of the output transistor DRV is connected to the output terminal of the inverting amplifier 40. In the following description, the output transistor DRV may also be referred to as a first transistor.

The differential amplifier circuit 30 is connected to provide negative feedback between a reference voltage VREF and a voltage based on the output voltage VOUT outputted from the output terminal TO. Specifically, the non-inverting input terminal of the differential amplifier circuit 30 receives the reference voltage VREF. In addition, the inverting input terminal of the differential amplifier circuit 30 receives a voltage obtained by dividing the output voltage VOUT by the resistor R11 and the resistor R12. In addition, the output terminal of the differential amplifier circuit 30 is connected to the inverting amplifier 40.

The inverting amplifier 40 is connected between the gate terminal of the output transistor DRV, the output terminal of the differential amplifier circuit 30, and the input terminal TI. The inverting amplifier 40 is a source-grounded amplifier circuit. Specifically, the inverting amplifier 40 includes a current adjustment circuit 10 and a transistor MN1. The current adjustment circuit 10 is connected between the input terminal TI, the gate terminal of the output transistor DRV, and the drain terminal of the transistor MN1. The gate terminal of the transistor MN1 is connected to the output terminal of the differential amplifier circuit 30, the drain terminal of the transistor MN1 is connected to the current adjustment circuit 10, and the source terminal of the transistor MN1 is grounded. In the following description, the transistor MN1 may also be referred to as a second transistor.

Herein, according to a circuit as described in the related art described above, a current mirror circuit is configured by a P-channel type MOSFET and an output transistor, and a current flowing from an input terminal to the P-channel type MOSFET is mirrored to flow a current to the output transistor. In the case where a current mirror ratio between the P-channel type MOSFET and the output transistor is very large, and the current flowing through the output transistor is small, i.e., in the case where a gate voltage of the output transistor is in the vicinity of a threshold voltage, the P-channel type MOSFET enters a weak inversion region, and the current flowing from the input terminal TI to the transistor MN1 (the current flowing to the P-channel type MOSFET) becomes very small.

In contrast, according to the present embodiment, the current adjustment circuit 10 can flow sufficient current from the input terminal TI to the transistor MN1 even with the gate voltage of the output transistor DRV being in the vicinity of the threshold voltage. In addition, as current can be flowed even with the gate voltage of the output transistor DRV being in the vicinity of the threshold voltage, even more current can be flowed from the input terminal TI to the transistor MN1 in the case where the gate voltage of the output transistor DRV becomes higher than the threshold voltage. By adopting such a configuration, a resistance of the current adjustment circuit 10 decreases, and a gain at the gate terminal of the output transistor DRV can be lowered.

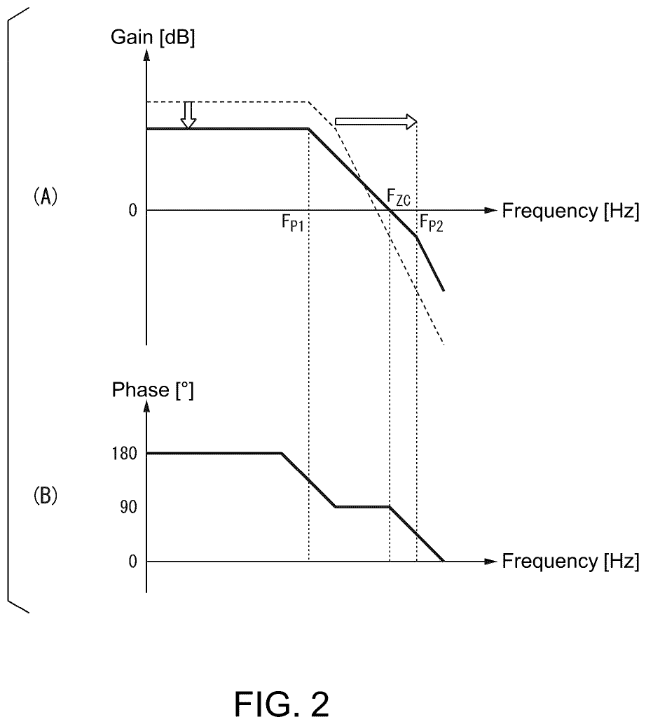

FIG. 2 is a graph illustrating changes in a gain and a phase upon varying a frequency in the case where a capacitance value of the output capacitor of the voltage regulator according to the first embodiment is small. The presented example illustrates changes in the gain and the phase upon varying the frequency in the case where the capacitance value of the output capacitor COUT in FIG. 1 is sufficient. (A) of FIG. 2 illustrates a relationship between the frequency [Hz] and the gain [dB], and (B) of FIG. 2 illustrates a relationship between the frequency [Hz] and the phase [°].

A frequency F_{P1} of a first pole is a frequency of the first pole generated by the output capacitor COUT. A frequency F_{P2} of a second pole is a frequency of the second pole generated by a parasitic capacitance formed between the source terminal and the gate terminal of the output transistor DRV.

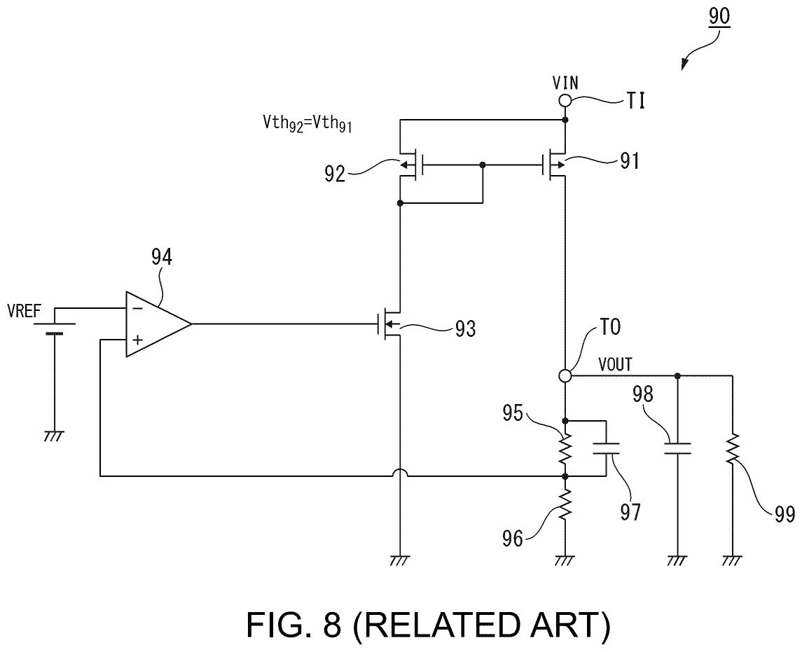

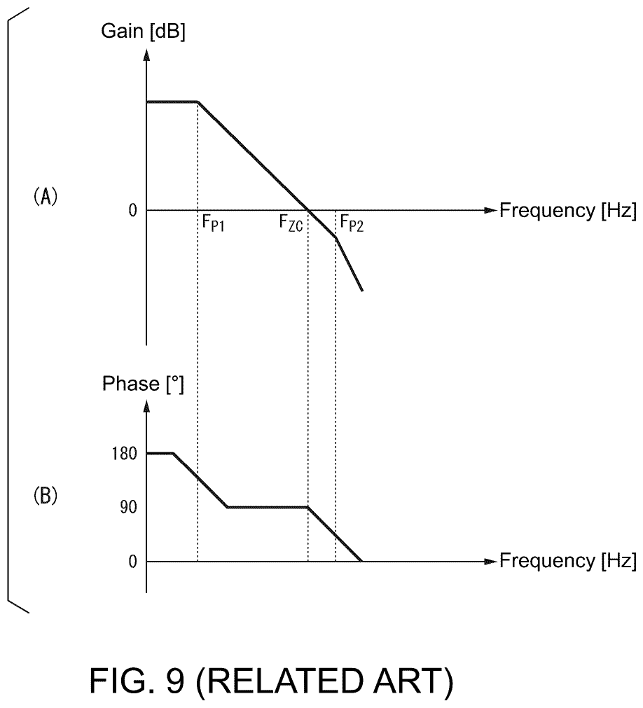

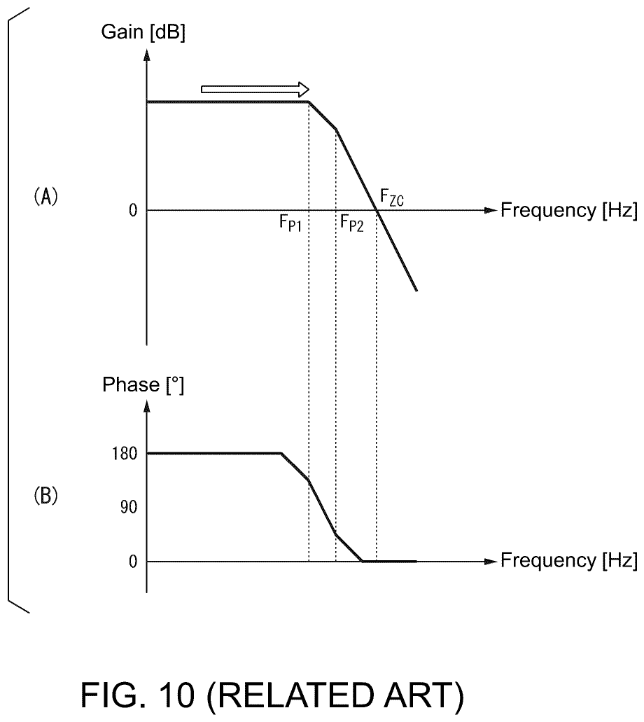

In (A) of FIG. 2, the relationship between the frequency [Hz] and the gain [dB] in the voltage regulator 1 according to the present embodiment is indicated by a solid line, and the relationship between the frequency [Hz] and the gain [dB] in a voltage regulator (e.g., the voltage regulator 90 illustrated in FIG. 8) according to the conventional art is indicated by a dashed line. (B) of FIG. 2 illustrates the relationship between the frequency [Hz] and the phase [°] in the voltage regulator 1 according to the present embodiment. As illustrated in the figure, according to the conventional art, the frequency F_{P1} of the first pole and the frequency F_{P2} of the second pole are close to each other, and phase compensation is difficult.

In contrast, according to the present embodiment, even in the case where the voltage at the gate terminal of the output transistor DRV is in the vicinity of the threshold voltage of the output transistor DRV, current can be drawn from the input terminal TI by the current adjustment circuit 10. Thus, the resistance of the current adjustment circuit 10 decreases, and the gain at the gate terminal of the output transistor DRV can be lowered. Consequently, the frequency F_{P2} of the second pole shifts to the high-frequency side. As a result of the frequency F_{P2} of the second pole shifting to the high-frequency side, the frequency F_{P1} of the first pole and the frequency F_{P2} of the second pole can be sufficiently separated (the bandwidths can be separated). According to the figure, the phase at a zero-crossing frequency F_{ZC} at which the gain becomes 0 [dB] is about 90[°], which is sufficiently greater than 0. Thus, according to the present embodiment, even in the case where the capacitance value of the output capacitor is reduced, phase compensation can be performed without significantly increasing a circuit area.

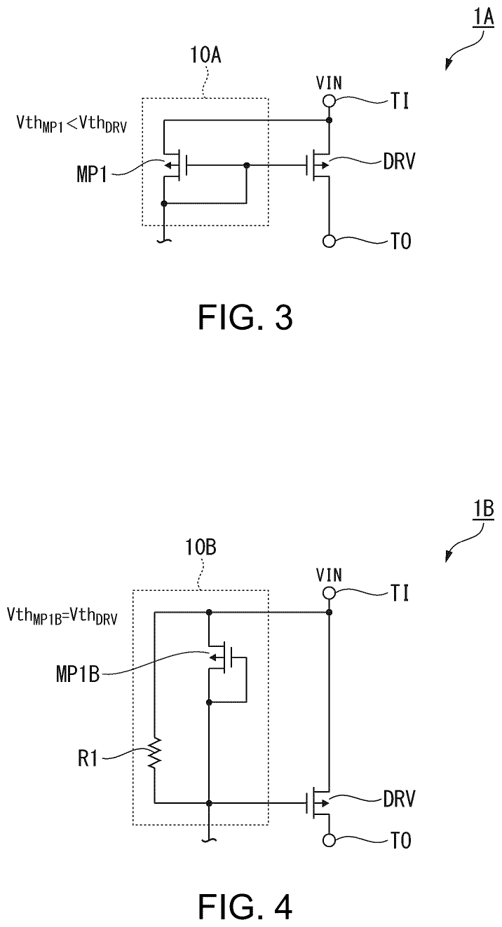

Next, a second embodiment to a sixth embodiment will be described with reference to FIG. 3 to FIG. 7. In the second embodiment to the sixth embodiment, specific aspects of the current adjustment circuit 10 will be described.

### Second Embodiment

FIG. 3 is a circuit diagram illustrating a voltage regulator according to a second embodiment. The second embodiment will be described with reference to this figure. A voltage regulator 1A according to the second embodiment differs from the voltage regulator 1 in that the voltage regulator 1A includes a current adjustment circuit 10A instead of the current adjustment circuit 10. In the description of the voltage regulator 1A, descriptions of configurations similar to those of the voltage regulator 1 may be omitted, with similar reference signs labeled or illustrations thereof omitted.

The current adjustment circuit 10A includes a transistor MP1. The transistor MP1 is connected to form a mirror configuration with the output transistor DRV. Specifically, the gate terminal of the transistor MP1 is connected to the gate terminal of the output transistor DRV, the drain terminal of the transistor MP1 is connected to the gate terminal of the transistor MP1, and the source terminal of the transistor MP1 is connected to the input terminal TI (the source terminal of the output transistor DRV). In the following description, the transistor MP1 may also be referred to as a third transistor.

In the second embodiment, by configuring the threshold voltage Vth_{MP1} of the transistor MP1 to be smaller than the threshold voltage Vth_{DRV} of the output transistor DRV, the current adjustment circuit 10A can flow sufficient current from the input terminal TI to the transistor MN1 even with the gate voltage of the output transistor DRV being in the vicinity of the threshold voltage.

By adopting such a configuration, as illustrated in FIG. 2, it becomes possible to lower the gain at the gate terminal of the output transistor DRV and shift the frequency F_{P2} of the pole (second pole) generated at the gate terminal to the high-frequency side.

According to the second embodiment, it is not required to include a large-area second output transistor in parallel with the output transistor as in the circuit described in the related art. Thus, according to the present embodiment, even in the case of reducing the capacitance value of the output capacitor, phase compensation can be easily performed without significantly increasing the circuit area.

### Third Embodiment

FIG. 4 is a circuit diagram illustrating a voltage regulator according to a third embodiment. The third embodiment will be described with reference to this figure. A voltage regulator 1B according to the third embodiment differs from the voltage regulator 1 in that the voltage regulator 1B includes a current adjustment circuit 10B instead of the current adjustment circuit 10. In the description of the voltage regulator 1B, descriptions of configurations similar to those of the voltage regulator 1 may be omitted, with similar reference signs labeled or illustrations thereof omitted.

The current adjustment circuit 10B includes a transistor MP1B and a resistor R1. The transistor MP1B is connected to form a mirror configuration with the output transistor DRV. Specifically, the gate terminal of the transistor MP1B is connected to the gate terminal of the output transistor DRV, the drain terminal of the transistor MP1B is connected to the gate terminal of the transistor MP1B, and the source terminal of the transistor MP1B is connected to the input terminal TI (the source terminal of the output transistor DRV). In the following description, the transistor MP1B may also be referred to as a fourth transistor.

The resistor R1 is connected in parallel with the transistor MP1B. Specifically, one terminal of the resistor R1 is connected to the source terminal of the transistor MP1B, and the other terminal of the resistor R1 is connected to the drain terminal of the transistor MP1B. In the following description, the resistor R1 may also be referred to as a first resistor.

In the third embodiment, the threshold voltage Vth_{DRV} of the output transistor DRV and the threshold voltage Vth_{MP1B} of the transistor MP1B are substantially the same. In other words, in the third embodiment, the output transistor DRV and the transistor MP1B with configurations similar to each other can be used. In the third embodiment, by inserting the resistor R1 in parallel with the transistor MP1B, the current adjustment circuit 10B can flow sufficient current from the input terminal TI to the transistor MN1 even with the gate voltage of the output transistor DRV being in the vicinity of the threshold voltage.

By adopting such a configuration, as illustrated in FIG. 2, it becomes possible to lower the gain at the gate terminal of the output transistor DRV and shift the frequency F_{P2} of the pole (second pole) generated at the gate terminal to the high-frequency side.

According to the third embodiment, it is not required to include a large-area second output transistor in parallel with the output transistor as in the circuit described in the related art. Thus, according to the present embodiment, even in the case of reducing the capacitance value of the output capacitor, phase compensation can be easily performed without significantly increasing the circuit area.

In the present embodiment, a range in which the threshold voltages of the transistors are substantially the same may be equivalent to, for example, a range in which the configurations of the transistors are substantially the same. At this time, a difference in sizes of the transistors does not pose an issue. In other words, the range in which the threshold voltages of the transistors are substantially the same broadly covers a range in which the threshold voltages of the transistors become substantially the same by including the same configuration, even though the sizes of the transistors differ.

### Fourth Embodiment

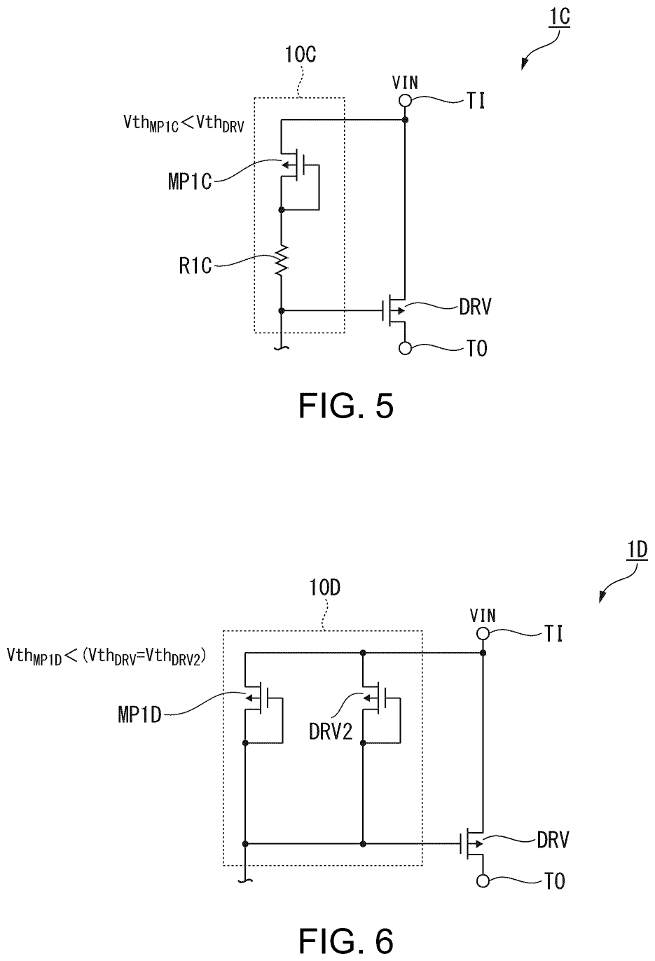

FIG. 5 is a circuit diagram illustrating a voltage regulator according to a fourth embodiment. The fourth embodiment will be described with reference to this figure. A voltage regulator 1C according to the fourth embodiment differs from the voltage regulator 1 in that the voltage regulator 1C includes a current adjustment circuit 10C instead of the current adjustment circuit 10. In the description of the voltage regulator 1C, descriptions of configurations similar to those of the voltage regulator 1 may be omitted, with similar reference signs labeled or illustrations thereof omitted.

The current adjustment circuit 10C includes a transistor MP1C and a resistor R1C. In the fourth embodiment, with respect to the configuration of the second embodiment, the resistor R1C is further connected in series to the drain side of the transistor MP1C. Specifically, the gate terminal and the drain terminal of the transistor MP1C are connected to each other, and the source terminal of the transistor MP1C is connected to the input terminal TI (the source terminal of the output transistor DRV). One terminal of the resistor R1C is connected to the drain terminal of the transistor MP1C, and the other terminal of the resistor R1C is connected to the gate terminal of the transistor MP1C. In the following description, the transistor MP1C may also be referred to as a fifth transistor, and the resistor R1C may also be referred to as a second resistor.

In the fourth embodiment, the threshold voltage Vth_{MP1C} of the transistor MP1C is smaller than the threshold voltage Vth_{DRV} of the output transistor DRV. Specifically, in the fourth embodiment, by configuring the threshold voltage of the transistor MP1C to be smaller than the threshold voltage of the output transistor DRV, the current adjustment circuit 10C can flow sufficient current from the input terminal TI to the transistor MN1 even with the gate voltage of the output transistor DRV being in the vicinity of the threshold voltage.

By adopting such a configuration, as illustrated in FIG. 2, it becomes possible to lower the gain at the gate terminal of the output transistor DRV and shift the frequency F_{P2} of the pole (second pole) generated at the gate terminal to the high-frequency side.

Herein, in the case where the threshold voltage of the transistor MP1C is configured to be smaller than the threshold voltage of the output transistor DRV, there is a concern that current may flow excessively to the current adjustment circuit 10. In the fourth embodiment, by further inserting the resistor RIC in series with the transistor MP1C, the drain current of the transistor MP1C is prevented from becoming excessively large. By adopting such a configuration, it becomes possible to suppress an overall current consumption of the voltage regulator 1C. In other words, according to the present embodiment, an effect of being capable of reducing power consumption can also be obtained. In addition, in the fourth embodiment, an effect of being capable of easily performing fine-tuning of the gain can also be obtained.

### Fifth Embodiment

FIG. 6 is a circuit diagram illustrating a voltage regulator according to a fifth embodiment. The fifth embodiment will be described with reference to this figure. A voltage regulator 1D according to the fifth embodiment differs from the voltage regulator 1 in that the voltage regulator 1D includes a current adjustment circuit 10D instead of the current adjustment circuit 10. In the description of the voltage regulator 1D, descriptions of configurations similar to those of the voltage regulator 1 may be omitted, with similar reference signs labeled or illustrations thereof omitted.

The current adjustment circuit 10D includes a transistor MP1D and a transistor DRV2. In the fifth embodiment, compared to the configuration in the third embodiment, instead of the resistor R1 connected in parallel with the transistor MP1B, the transistor MP1D is connected to form a mirror configuration with the output transistor DRV. Specifically, the gate terminal and the drain terminal of the transistor MP1D are connected to each other and are connected to the gate terminal of the output transistor DRV. In addition, the source terminal of the transistor MP1D is connected to the input terminal TI (the source terminal of the output transistor DRV). In addition, the gate terminal and the drain terminal of the transistor DRV2 are connected to each other and are connected to the gate terminal of the output transistor DRV. In addition, the source terminal of the transistor DRV2 is connected to the input terminal TI (the source terminal of the output transistor DRV). In the following description, the transistor MP1D may also be referred to as a sixth transistor, and the transistor DRV2 may also be referred to as a seventh transistor.

In the fifth embodiment, the threshold voltage Vth_{MP1D} of the transistor MP1D is smaller than the threshold voltage VthDRV of the output transistor DRV. On the other hand, the threshold voltage Vth_{DRV2} of the transistor DRV2 is substantially the same as the threshold voltage Vth_{DRV} of the output transistor DRV. In other words, in the fifth embodiment, the output transistor DRV and the transistor DRV2 can include configurations similar to each other. In the fifth embodiment, by connecting the transistor MP1D with a smaller threshold voltage in parallel with the transistor DRV2, the current adjustment circuit 10D can flow sufficient current from the input terminal TI to the transistor MN1 even with the gate voltage of the output transistor DRV being in the vicinity of the threshold voltage.

By adopting such a configuration, as illustrated in FIG. 2, it becomes possible to lower the gain at the gate terminal of the output transistor DRV and shift the frequency F_{P2} of the pole (second pole) generated at the gate terminal to the high-frequency side.

Furthermore, in the fifth embodiment, the area of the transistor DRV2 can be equal to that of the transistor in the conventional circuit, and the area of the transistor MP1D can also be realized to be about the same as that of the transistor DRV2. Thus, according to the present embodiment, it is not required to include a large-area second output transistor in parallel with the output transistor as in the circuit described in the related art. Consequently, according to the present embodiment, even in the case of reducing the capacitance value of the output capacitor, it is possible to perform phase compensation easily without significantly increasing the circuit area.

### Sixth Embodiment

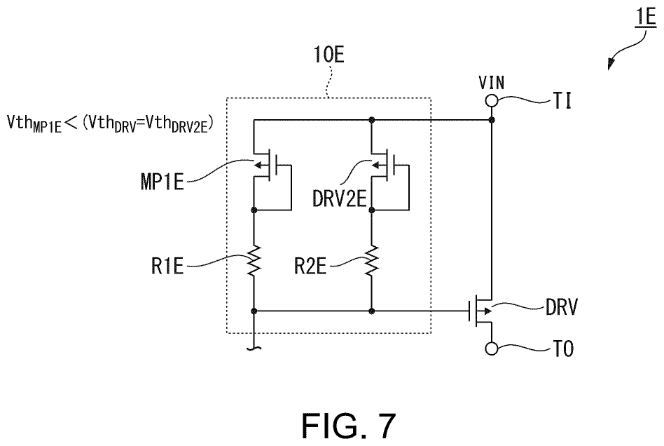

FIG. 7 is a circuit diagram illustrating a voltage regulator according to a sixth embodiment. The sixth embodiment will be described with reference to this figure. A voltage regulator 1E according to the sixth embodiment differs from the voltage regulator 1 in that the voltage regulator 1E includes a current adjustment circuit 10E instead of the current adjustment circuit 10. In the description of the voltage regulator 1E, descriptions of configurations similar to those of the voltage regulator 1 may be omitted, with similar reference signs labeled or illustrations thereof omitted.

The current adjustment circuit 10E includes a transistor MP1E, a transistor DRV2E, a resistor R1E, and a resistor R2E. In the sixth embodiment, with respect to the configuration in the fifth embodiment, the resistor R1E is further connected in series with the transistor MP1E, and the resistor R2E is further connected in series with the transistor DRV2E. Specifically, the gate terminal and the drain terminal of the transistor MP1E are connected to each other, and the source terminal of the transistor MP1E is connected to the input terminal TI (the source terminal of the output transistor DRV). In addition, the gate terminal and the drain terminal of the transistor DRV2E are connected to each other, and the source terminal of the transistor DRV2E is connected to the input terminal TI (the source terminal of the output transistor DRV). One terminal of the resistor R1E is connected to the drain terminal of the transistor MP1E, and the other terminal of the resistor R1E is connected to the gate terminal of the output transistor DRV. In addition, one terminal of the resistor R2E is connected to the drain terminal of the transistor DRV2E, and the other terminal of the resistor R2E is connected to the gate terminal of the output transistor DRV. In the following description, the transistor MP1E may also be referred to as an eighth transistor, the transistor DRV2E may also be referred to as a ninth transistor, the resistor R1E may also be referred to as a third resistor, and the resistor R2E may also be referred to as a fourth resistor.

In the sixth embodiment, the threshold voltage Vth_{MP1E} of the transistor MP1E is smaller than the threshold voltage Vth_{DRV} of the output transistor DRV. On the other hand, the threshold voltage Vth_{DRV2E} of the transistor DRV2E is substantially the same as the threshold voltage Vth_{DRV} of the output transistor DRV. In other words, in the sixth embodiment, the output transistor DRV and the transistor DRV2E can include configurations similar to each other. In the sixth embodiment, by connecting the transistor MP1E with a smaller threshold voltage in parallel with the transistor DRV2E, the current adjustment circuit 10E can flow sufficient current from the input terminal TI to the transistor MN1 even with the gate voltage of the output transistor DRV being in the vicinity of the threshold voltage.

By adopting such a configuration, as illustrated in FIG. 2, it becomes possible to lower the gain at the gate terminal of the output transistor DRV and shift the frequency F_{P2} of the pole (second pole) generated at the gate terminal to the high-frequency side.

Furthermore, in the sixth embodiment, the area of the transistor DRV2E can be equal to that of the transistor in the conventional circuit, and the area of the transistor MP1E can also be realized to be about the same as that of the transistor DRV2E. Thus, according to the present embodiment, it is not required to include a large-area second output transistor in parallel with the output transistor as in the circuit described in the related art. Consequently, according to the present embodiment, even in the case of reducing the capacitance value of the output capacitor, it is possible to perform phase compensation easily without significantly increasing the area.

Furthermore, in the sixth embodiment, by inserting the resistor R1E in series with the transistor MP1E, the drain current of the transistor MP1E is prevented from becoming excessively large. In addition, by inserting the resistor R2E in series with the transistor DRV2E, the drain current of the transistor DRV2E is prevented from becoming excessively large. By adopting such a configuration, it becomes possible to suppress an overall current consumption of the voltage regulator 1E. In other words, according to the present embodiment, an effect of being capable of reducing power consumption can also be obtained. In addition, in the sixth embodiment, an effect of being capable of easily performing fine-tuning of the gain can also be obtained.

The voltage regulator 1, 1A, 1B, 1C, 1D, or 1E according to the present embodiment may be realized as a predetermined semiconductor device. The semiconductor device may be any semiconductor device at least including the voltage regulator 1, 1A, 1B, 1C, 1D, or 1E. The semiconductor device may also include a predetermined control circuit, peripheral circuits, etc., in addition to the voltage regulator 1, 1A, 1B, 1C, 1D, or 1E.

Although configurations for implementing the present invention have been described above based on the embodiments, specific aspects according to the present invention are not limited to these embodiments in any manner, and various modifications, substitutions, and design changes may be made within a scope without deviating from the spirit of the present invention. For example, similar effects may also be obtained by interchanging all NMOS transistors and PMOS transistors to configure the circuit in an inverted manner.

In addition, the present invention may also be implemented by combining the embodiments described above and the configurations described in each embodiment.

What is claimed is:

1. A voltage regulator comprising:
a first transistor provided between an input terminal to which an input voltage is applied and an output terminal from which an output voltage is outputted;
a differential amplifier circuit connected to provide negative feedback between a predetermined reference voltage and a voltage based on the output voltage outputted from the output terminal; and
an inverting amplifier connected to an output terminal of the differential amplifier circuit, a gate terminal of the first transistor, and the input terminal, wherein
the inverting amplifier comprises:
a second transistor comprising a gate terminal connected to the output terminal of the differential amplifier circuit, and a source terminal which is grounded; and
a current adjustment circuit capable of flowing current from the input terminal to the second transistor even with a gate voltage of the first transistor being in the vicinity of a threshold voltage.

2. The voltage regulator according to claim 1, wherein
the current adjustment circuit comprises a third transistor, the third transistor comprising a gate terminal connected to the gate terminal of the first transistor, a drain terminal connected to the gate terminal of the third transistor, and a source terminal connected to the input terminal, wherein a threshold voltage of the third transistor is smaller than the threshold voltage of the first transistor.

3. The voltage regulator according to claim 1, wherein
the current adjustment circuit comprises:
a fourth transistor comprising a gate terminal connected to the gate terminal of the first transistor, a drain terminal connected to the gate terminal of the fourth transistor, and a source terminal connected to the input terminal, wherein a threshold voltage of the fourth transistor is substantially the same as the threshold voltage of the first transistor; and
a first resistor comprising one terminal connected to the source terminal of the fourth transistor, and the other terminal connected to the drain terminal of the fourth transistor.

4. The voltage regulator according to claim 1, wherein
the current adjustment circuit comprises:
a fifth transistor comprising a gate terminal and a drain terminal connected to each other, and a source terminal connected to the input terminal, wherein a threshold voltage of the fifth transistor is smaller than the threshold voltage of the first transistor; and
a second resistor comprising one terminal connected to the drain terminal of the fifth transistor, and the other terminal connected to the gate terminal of the first transistor.

5. The voltage regulator according to claim 1, wherein
the current adjustment circuit comprises:
a sixth transistor comprising a gate terminal and a drain terminal connected to the gate terminal of the first transistor, and a source terminal connected to the input terminal, wherein a threshold voltage of the sixth transistor is smaller than the threshold voltage of the first transistor; and
a seventh transistor comprising a gate terminal and a drain terminal connected to the gate terminal of the first transistor, and a source terminal connected to the input terminal, wherein a threshold voltage of the seventh transistor is substantially the same as the threshold voltage of the first transistor.

6. The voltage regulator according to claim 1, wherein
the current adjustment circuit comprises:
an eighth transistor comprising a gate terminal and a drain terminal connected to each other, and a source terminal connected to the input terminal, wherein a threshold voltage of the eighth transistor is smaller than the threshold voltage of the first transistor;
a third resistor comprising one terminal connected to the drain terminal of the eighth transistor, and the other terminal connected to the gate terminal of the first transistor;
a ninth transistor comprising a gate terminal and a drain terminal connected to each other, and a source terminal connected to the input terminal, wherein a threshold voltage of the ninth transistor is substantially the same as the threshold voltage of the first transistor; and
a fourth resistor comprising one terminal connected to the drain terminal of the ninth transistor, and the other terminal connected to the gate terminal of the first transistor.

7. A semiconductor device comprising the voltage regulator according to claim 1.
